(19) United States
(12) Patent Application Publication
(10) Pub. No.: US 2011/0292222 A1
(43) Pub. Date: Dec. 1, 2011

(54) Photo-video player with automatic image file size reduction

(75) Inventor: Vern Klein, Pleasanton, CA (US)

(73) Assignee: EU3C Company, Limited

(21) Appl. No.: 13/134,099

(22) Filed: May 27, 2011

Related U.S. Application Data
(60) Provisional application No. 61/396,609, filed on May 28, 2010.

(51) Int. Cl. H04N 5/225

(52) U.S. Cl. 348/207.1; 348/E05.024

(57) ABSTRACT

This invention is a photo-video player with automatic image file size reduction. The photo-video player receives digital photos and digital videos from a digital camera, automatically reduces the image file size per pre-programmed instructions, and automatically saves the reduced-size image file. The photo-video player acts as a storage facility for the digital photos and digital videos, as well as a useful tool for displaying, managing, and editing said digital photos and digital videos. The photo-video player is designed to fit into the living room TV electronics suite; connected to the TV and alongside common TV peripherals such as a DVD player, cable/satellite receiver, DVR, etc. The photo-video player provides a back up storage system to protect against the entire loss of the image data in case the original image information is lost or deleted.

This Patent Application is a Non-provisional Application and claims the Priority Date of a Provisional Application 61/396,609 filed by the Applicant of this Application on May 28, 2010. The disclosures made in Application 61/396,609 are hereby incorporated by reference in this Patent Application.

### BACKGROUND OF THE INVENTION

1. Field of the Invention

This invention relates generally to methods and devices to receive and process digital image data and to carry out image display according to the input digital data. More particularly, this invention relates to photo-video storage and display devices which store and display digital photos and digital video captured by digital still cameras and digital video cameras, collectively referred to as digital cameras, with automatic image-file size reduction.

2. Description of the Related Art

Digital camera usage has become very popular and pervasive throughout the world, especially with the advent of digital cameras being integrated into mobile phones. Digital camera users have many options for storing and displaying their digital photos and digital videos. Most of the options revolve around the personal computer environment, however many new novel systems have been deployed to also enable the digital camera user to store and display their digital photos and digital videos in a TV environment. The existing systems for storing and displaying digital photos and videos in the TV environment include: media players, Digital Video Recorders (DVRs), flash card readers with TV output, digital still cameras with TV output, digital video cameras with TV output, TV sets with digital photo and digital video interfaces and TV sets with built in media players.

The existing systems for storing and displaying digital photos and digital videos in the TV environment are designed to store whatever image data file size it is provided, and those image data file sizes are typically quite large. For example, if a digital photo is captured by a high resolution, e.g., twelve megapixel, digital still camera, the file size could be as large as seventy-two megabytes per photo (assuming two bytes per pixel per color channel RGB), or in the order of two to three megabytes per photo for an average JPEG version. In the case of digital video, high definition (HD) digital video file sizes are typically in the order of gigabyte(s) per hour of video. Thus, the existing systems for storing and displaying digital photos and digital videos require large amounts of storage in order to store the typically provided digital photo and digital video file sizes.

The existing systems for storing and displaying digital photos and digital videos in the TV environment are also designed to only decode the image data. The decoding process and decoder capabilities of existing systems are typically not implemented and fully equipped with the more complicated and more expensive electronics as that required for carrying out the encoding and compression of digital images as the encoders implemented in digital cameras.

While high resolution image files can typically provide better output image quality, the output image quality is limited by the display capabilities of the output display devices. Thus, while a high resolution image file from a twelve megapixel digital camera can benefit a large format (greater than twenty by thirty inches) hard copy photo print; this high resolution image file will not be of benefit if the output display device is a 1080p HD television screen. This is because a 1080p HD television screen has a resolution of only two megapixels (1920×1080 pixels) and, therefore, a high resolution image file from a twelve megapixel digital camera will have to be reduced in resolution, by processing it, in order to match the capability of the output display. Thus, much of the twelve megapixel image data file is “thrown away” in processing the twelve megapixel image data down to the two megapixel image display.

If the main desire is to show still image data on a lower resolution display, for example on a 1080p HD television or on the 320×240 dpi LCD display of a mobile device, the existing systems for storing and displaying digital photos in the TV environment are not efficient because they retain the large file size, high resolution data and yet display it on a lower resolution display. This inefficiency is manifested in higher costs for the required additional storage capacity and in slower processing times for working with the larger, higher resolution image data files. Retaining and processing the larger, higher resolution image data files can also be limiting on the type of digital storage solutions that can be economically deployed. For instance, smaller file sizes can make solid state storage solutions, such as flash memory, more economically viable, whereas larger file sizes tend to require other storage solutions, such as hard disk drives. Being able to deploy solid state storage solutions is beneficial because solid state storage solutions have no moving parts and thereby are not subject to the mechanical failure issues of hard drives. Also, with ever advancing semiconductor technology, solid state storage solutions will provide higher and higher capacities at lower and lower costs.

The existing systems for storing and displaying digital videos in the TV environment are matched and efficient from an image resolution perspective. This is because typical video data is specifically designed to match the television display resolutions. However, the existing systems for storing and displaying digital videos in the TV environment fall short because they do not have an automatic process to reduce the file size of the video data. Many benefits can be derived from reducing the file size of the provided video data, including:
the ability to more quickly peruse the video files, including opening/closing the files and fast forwarding/reversing the files
the increased viability of deploying solid state flash memory solutions as the primary storage mechanism
the ability to create and manage exportable files better suited for the internet and mobile devices

Due to these limitations, the functions of the existing systems for storing and displaying digital photos and digital videos in the TV environment are limited because there are no processes available to remotely control and automatically synchronize the edited images with mobile devices, such as the iPod or iPad devices, so that a user can conveniently view the images on the portable devices.

Limited by the large file sizes of digital photos and digital videos and its associated extra processing burden, the existing systems for storing and displaying digital photos and digital videos in the TV environment are not implemented to accommodate operation with flash memory cards as the primary storage memory, nor can the user increase the storage capacity by adding more flash memory cards.

Additional functions such as remote control to carry out image editing including deleting, zooming in/out and auto control of colors, brightness, contrast; crop and rotation of the photo-video images are not implemented due to these limitations.

For these reasons, a need still exists to implement a new photo-video image display controller to resolve the above discussed difficulties and limitations as now confronted by current technologies in displaying the photo-video images on display devices such as televisions.

### SUMMARY OF THE PRESENT INVENTION

One aspect of this invention is to provide an improved photo-video player to receive digital image data from a digital camera as a file containing a large amount of high resolution data and the photo-video player is implemented with a processor and data reduction program to automatically reduce the image data file size to make it suitable to display the image on a TV display device and to store the reduced size image file. The photo-video player comprises input ports to receive digital photos and digital videos from a digital camera. The photo-video player includes a data-storage to store the input image data. The processor of the photo-video player automatically executes a data reduction program to carry out pre-programmed instructions to reduce the image file size. The photo-video player further functions as a storage facility for the digital photos and digital videos, as well as a useful tool for displaying, managing, and editing said digital photos and digital videos.

It is another aspect of this invention to reduce the still image file sizes such that the still image file may be conveniently stored in a solid state storage, such as flash memory. Therefore, a more economically viable solid state storage can be implemented without requiring a data-storage device for larger file sizes such as a hard disk drive.

It is further an aspect of this invention to provide a new and improved photo-video player that is designed to connect to and fit into the living room TV electronics suite. The photo-video player is implemented to function alongside and be compatible to broad varieties of common TV peripherals such as a DVD player, cable/satellite receiver, DVR, etc.

Another aspect of this invention is to provide a photo-video player that can further function as a backup storage system to store the image data captured and input from a digital camera and also store the image data with reduced file size after being processed by the photo-video player for displaying the image on a TV set. The photo-video data can therefore prevent the loss of the image data in case that the original image data is lost or deleted.

It is another aspect of this invention to reduce the video image file sizes such that the video image file may be conveniently stored in a solid state storage, such as flash memory. Therefore, a more economically viable solid state storage can be implemented without requiring a data-storage device for larger file sizes such as a hard disk drive.

It is another aspect of this invention to reduce the video image file sizes such that the video image file may be more convenient and suitable for internet transmission and for exporting to a mobile device.

It is another aspect of this invention to reduce the video image file sizes such that the video image file may be more easily and quickly processed allowing the faster perusal of video files. Previewing the video image file can be performed more quickly and efficiently in the low resolution video file and then software allows the user to jump over to the high resolution version.

Another aspect of this invention is to provide a flash memory storage expansion module in the photo-video player such that a user can increase the storage capacity by adding more flash memory cards.

Another aspect of this invention is to provide a feature on the photo-video player to allow a user to apply a custom remote control device which is equipped with buttons to control image editing such as delete, zoom in and zoom out, adjust colors, adjust brightness, adjust contrast, crop and rotate.

Another aspect of this invention is to provide a function on the photo-video player for synchronizing the image data with an external mobile device.

Specifically, the photo-video player of this invention includes I/O ports and data processing and handling subsystems to carry out the following functions.
interface with digital cameras
optimize the display of photos and videos on the TV
file and organize large quantities of digital photos and digital videos
edit digital photos and digital video
create, display and export slideshows of the digital photos and digital videos
play digital music (e.g., MP3 and AAC files) and enable digital music to be incorporated into slideshows
export digital photos and digital videos to other devices
provide an intuitive user interface optimized to the task of managing digital photos and digital videos, including screen menu systems, remote controllers and an onscreen help menu system
automatically back up digital photos and digital videos in multiple locations to guard against accidental deletion
enable the addition, in a daisy chain fashion, of additional storage
operate independently from a PC
interface to a PC network and the internet

These and other aspects, functions, objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 shows the typical high level system configuration and connections for operating the photo-video player of this invention.

FIG. 2 shows the front panel of the photo-video player.

FIG. 3 shows the rear panel of the photo-video player.

FIG. 4 shows a functional block diagram for showing the hardware components of the photo-video player.

FIG. 5 shows the user interface home screen and a remote control device for operating the photo-video player of this invention.

FIG. 6 shows additional solid state memory expansion modules connected to the photo-video player.

FIG. 7 shows an external mobile device, running an application that coordinates the import/export interface with the photo-video player, as well as provides image database synchronization and coordinated user interface with the photo-video player.

### DETAILED DESCRIPTION OF THE PREFERRED EMBODIMENT

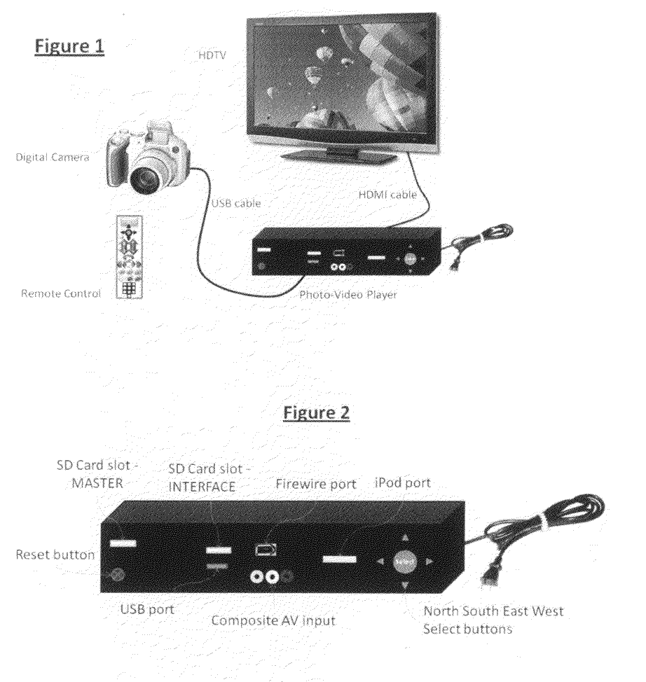

FIG. 1 shows the standard system configuration to show a high level connection of systems for operating the photo-video player. The photo-video player is connected to a High Definition (HD) television via the typical methods including composite AV cables, component AV cables, or HDMI. The photo-video player is controlled via a remote control device. Digital photo and digital video image data from a digital camera is downloaded to the photo-video player, in this case via a USB cable. The photo-video player receives the image data, automatically reduces the file sizes of the digital photos and digital videos and stores the file with reduce file size to solid state memory, in this case an SD card. The images are then output from the photo-video player and displayed on the HD television.

FIG. 2 shows the front panel of the photo-video player. The “north, south, east, west, select” buttons are used to control the photo-video player via the application menus that appear on the TV screen. The remote control has the same buttons and can be used instead. The “SD card slot—MASTER” houses the SD card that is used to retain stored digital photos and digital videos. A user downloads their digital photos and digital videos from their digital camera in a variety of ways. The photo-video player automatically reduces the file sizes of the digital photos and digital videos and stores them to the SD card housed in the “SD card slot—MASTER”. Other types of solid state flash memory can be used instead of SD.

The ways that digital photos and digital videos are downloaded from a digital camera to the photo-video player include:
via a USB connection from the digital camera to the photo-video player USB port
via removing the SD card from the digital camera and inserting it into the SD card slot—INTERFACE. Other types of solid state flash memory can be used instead of SD
via a Firewire connection from the digital camera to the photo-video player Firewire port
via an Apple iPod connection from an iPod, or other iPod compatible device, to the photo-video player iPod port

The photo-video player can accept an analog video stream via a composite AV cable (composite video plus left and right audio) connection from an analog camera. In this case, the photo-video player performs a digital conversion on the analog video, and stores the resulting digital video to the SD card MASTER.

The photo-video player can export digital photo and digital video data from its SD card MASTER storage to another digital data storage device via the USB port, SD card slot—INTERFACE, Firewire port and the iPod port. Other digital data storage devices include devices such as hard drives, iPod type devices, solid state drives and digital camera storage.

The photo-video player can import and export digital audio data, such as mp3 files, in the same manner as digital image data.

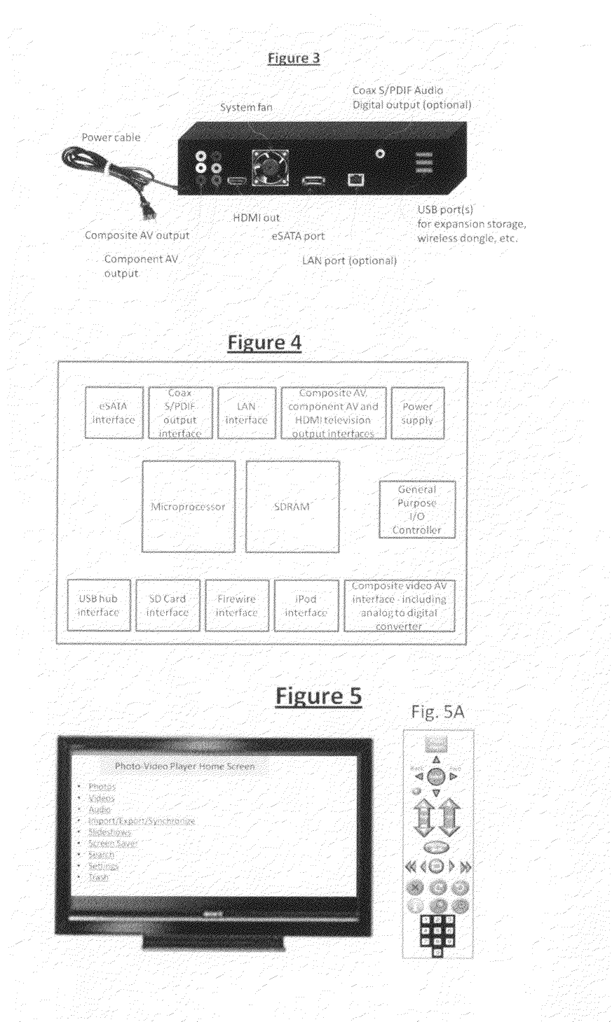

FIG. 3 shows the rear panel of the photo-video player. The items provided here include:
the power supply
a composite AV output, component AV output and an HDMI output for connecting the photo-video player to a TV
an eSATA port for connecting an external hard disk storage device
a LAN port for connecting the photo-video player to a computer network and the internet
a coax S/PDIF audio digital output for transferring audio to a compatible S/PDIF receiver device
USB ports for expanded storage and wireless network dongles

The expanded storage capacity enabled by the eSATA port and USB ports can be used to increase the storage capacity of the MASTER memory. When importing digital photos and digital videos, the photo-video player automatically reduces the file sizes of the digital photos and digital videos and stores them to the SD card housed in the “SD card slot—MASTER”. However, the photo-video player can be instead pre-programmed to store the reduced file size photos and videos to an alternative storage device connected to the eSATA or USB ports. Or, the photo-video player can be pre-programmed to store a non-reduced image file size i.e., the original image file size, to the storage devices instead.

FIG. 4 shows a block diagram of the hardware components of the photo-video player.
Central microprocessor and system memory
USB hub interface and controller
Composite video-AV interface and analog to digital converter and controller to convert the analog signal to a digital signal
SD card interface and controller
eSATA interface and controller
Firewire interface and controller
iPod interface and controller
General Purpose I/O controller for north, south, east, west, select button, and reset button, interface and control
Composite AV, component AV, and HDMI television signal controller and output
Coax S/PDIF controller and output
LAN interface and controller
Power supply

The microprocessor performs many tasks including many of the controller functions outlined above. In addition the microprocessor manages the user interface, and the user interface tasks, that are displayed on the television display, and the microprocessor performs the digital image encoding and compression needed to automatically reduce the image file size of digital photos and videos. Image compression for still images is most commonly performed to the JPEG standard, and digital videos are typically compressed using H.264 encoding. The microprocessor also performs the image aspect ratio conversion necessary to optimize the match up of the captured image aspect ratio to the television display aspect ratio. For example, a 35 mm digital photograph saves images that have an aspect ratio of 3:2 (the width is 3× and the height is 2×). However, an HD television may have an aspect ratio of 16:9. Thus the microprocessor needs to provide various eye-appealing conversions to modify a 3:2 photo so that it looks good on a 16:9 television.

More specifically, the following steps are carried out by the either the software programs implemented in a processor and/or hardware components to perform the functions as now achieved in the new and improved photo-video player of this invention.

1. Download from digital camera and automatic image file size reduction sequence
Check: is the file a still image or video image?
   if still image
      open and decode the file
      note aspect ratio and corresponding resolution
      if the resolution of the still image is less than or equal to the resolution of the target display (pre-defined) then save to master memory
      otherwise, compress the resolution of the image file to the resolution of the display, adjust for an aspect ratio mismatch between the image and the display then save the image file to master memory
   if video
      open and decode the video file header
      note aspect ratio and corresponding resolution
      if the resolution of the video is less than or equal to the pre-defined target resolution, save to master memory
      otherwise, compress the resolution of the image file to the pre-defined target resolution, adjust any aspect ratio mismatch between the video and the target aspect ratio then store the video file to master memory
         2. Pre-defined Setup options
specify TV display parameters (1080p, 720p, 1080i, etc.)
specify TV aspect ratio (1920×1080, 1280×720, 452×480, etc.)

Note, if the device is connected to a TV display via an HDMI cable, such information can be obtained in the device identification section

3. Encoding, decoding and aspect ratio adaption

Methods for encoding and decoding digital still images and digital videos, as well as methods for adapting for aspect ratio mismatches are well understood for those skilled in the art. Still images are most commonly decoded, and encoded, using the JPEG image compression standard. However other still image encoding standards could be applied such as TIFF, BMP, etc. Video images can be decoded and encoded using the various digital video standard including H.264, MOV, MPG, MP4, WMV, AVI, etc. Common methods for correcting aspect ratio mismatches include cropping, zooming, and stretching the images and video to achieve the desired correction.

4. Decoding still image and video files from master memory and displaying the results
Is the file a still image or video image?
   if still image
      Decode the image stored in the master memory
      adjust the aspect ratio of the image file, per the pre-defined method
      Display the image
   if video
      Decode the video stored in master memory
      Display the video stored in master memory
         5. Video thumbnail feature

The user can play, pause, fast forward, fast reverse, stop per normal linear video recording, but also can jump to any segment of the video in a random access manner. The user can also switch back and forth from the low resolution version stored in master memory, to the high resolution version stored in supplemental memory. The processor transfers pointer information between the high resolution and low resolution video files to enable seamless transitions.

FIG. 5 shows the user interface home screen and remote control. The user interface enables users to:
View, file and organize photos, videos, audio files and slideshows
Edit photos and video including delete, zoom in and zoom out, adjust colors, adjust brightness, adjust contrast, crop and rotate
Create, edit and display slide shows
Play music
Export photos, videos, audio and slideshows
Manage the system setup including: time, menu language, screen saver, format memory, update firmware, TV system information, video aspect ratio, video scaling option, recording quality, recording device, audio output, network connections

The user interface is managed via a remote control device, see FIG. 5A, although the user interface can also be managed via the north, south, east, west and select buttons found on the front panel of the photo-video player.

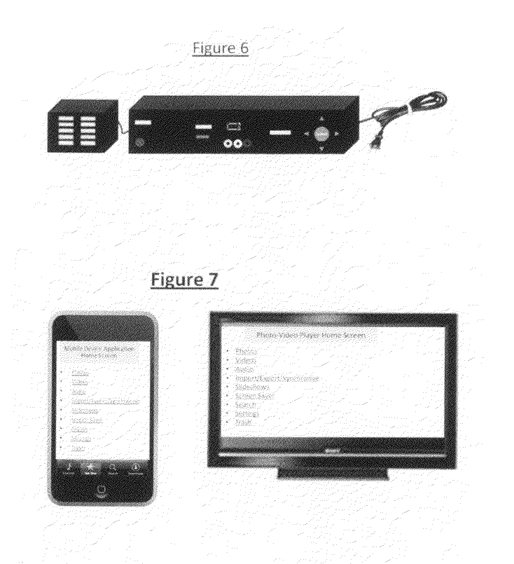

FIG. 6 shows how additional solid state memory expansion modules can be connected to the photo-video player. A solid state memory expansion module can be used to provide additional storage slots for: 1) automatically reduced file size image data, 2) non-reduced file size image data i.e., the original image data files, or 3) both. This provides the benefit of being a back up storage solution for the original file size data, but also the photo-video player can correlate a reduced file size video file, typically 320×240 pixels, to the original, high resolution file size—typically 1920×1080 1080p HD quality, so that the user can peruse video files quickly in the reduced file size version and yet quickly be able to view the high resolution video when desired.

FIG. 7 shows an external mobile device, for example an Apple iPhone, running an application that coordinates the import/export interface with the photo-video player, as well as provides image database synchronization and coordinated user interface with the photo-video player. The data is transferred to and from the mobile device and the photo-video player via the Apple iPod cable/port, the USB cable/port or by SD memory card transfer.

The photo-video player is shown as a standalone peripheral, however it could be incorporated into the TV itself, or another TV peripheral device such as a DVR or Blue-Ray Disk Player.

The photo-video player is shown using SD Card solid state memory, however other solid state storage devices could be used, including Compact Flash, Memory Stick, USB flash drives, etc., as well as other digital storage devices such as hard disk drives.

The photo-video player is shown to reduce the file size by reducing the resolution of the images, yet other mechanisms can also be deployed such as higher image compression of the JPEG image using JPEG image compression techniques, and lowering the frame rate of the video and other compression techniques for compressing video.

This photo-video player with automatic image file size reduction is therefore provided to store and display digital photos and digital video captured by digital still cameras and digital video cameras (collectively referred to as digital cameras). The photo-video player may be implemented with different kinds of media players such as Digital Video Recorders (DVRs), flash card readers with TV output, digital still cameras with TV output, digital video cameras with TV output, TV sets with a digital photo and digital interfaces and TV sets with built in media players. Such devices store digital media content, such as digital video, digital music and digital photos, and process the images for display on television sets. The invention further utilizes storage in the form of: solid state flash memory (e.g., SD Card, Compact Flash, USB flash drive, Memory Stick), hard disks, DVDs, BluRay disks or other digital media storage devices.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. An electronic photo-video player and image storage device comprising:
a user port for connecting to a digital camera to download digital photo and video data from a digital camera wherein the electronic photo-video player and image storage device further automatically processes the digital photo and video data into display data wherein the display data has a reduced amount of data compared with the digital photo and video data in order to match the resolution of a display device for displaying a photo and video image captured by the digital camera.

2. The electronic photo-video player and image storage device of claim 1 further comprising:
a data storage module to store the display data processed by the electronic photo-video player and image storage device and/or the digital photo and video data downloaded from the digital camera.

3. The electronic photo-video player and image storage device of claim 1 further comprising:
flash memory (e.g., SD card, Compact Flash, USB Flash Drive, etc.) expansion modules to store the display data processed by the electronic photo-video player and image storage device and/or the digital photo and video data downloaded from the digital camera.

4. The electronic photo-video player and image storage device of claim 1 further comprising:
a display data output port for connecting to a display device for automatically detecting the resolution of the display device to automatically process the digital photo and video data into the display data with the reduced amount of data matching with the resolution of the display device.

5. The electronic photo-video player and image storage device of claim 1 further comprising:
a display data output port for connecting to a television (TV) display device for automatically detecting the resolution of the TV display device to automatically process the digital photo and video data into the display data with the reduced amount of data matching with the resolution of the TV display device.

6. The electronic photo-video player and image storage device of claim 1 further comprising:
a display data output port for connecting to a high definition television (HDTV) display device for automatically detecting the resolution of a HDTV display device to automatically process the digital photo and video data into the display data with the reduced amount of data matching with the resolution of the TV display device for displaying a high definition (HD) (e.g., 1080p, 1080i, 720p, 720i, etc.) image.

7. The electronic photo-video player and image storage device of claim 1 further comprising:
a user interface to display a setup menu to allow a user to select a resolution of the display device to process the digital photo and video data into the display data with the reduced amount of data matching with the resolution of the display device.

8. The electronic photo-video player and image storage device of claim 1 further comprising:
a user interface to display a setup menu to allow a user to select a resolution of a television (TV) display device to process the digital photo and video data into the display data with the reduced amount of data matching with the resolution of the TV display device.

9. The electronic photo-video player and image storage device of claim 1 further comprising:
a user interface to display a setup menu to allow a user to select a resolution of a high definition television (HDTV) display device to process the digital photo and video data into the display data with the reduced amount of data matching with the resolution of the HDTV display device for displaying a high definition (HD) (e.g., 1080p, 1080i, 720p, 720i, etc.) image.

10. The electronic photo-video player and image storage device of claim 1 further comprising:
a display data output port for exporting to a mobile display device for automatically detecting the resolution of the mobile display device to automatically process the digital photo and video data into the mobile display data with the reduced amount of data matching with the resolution of the mobile display device.

11. The electronic photo-video player and image storage device of claim 1 further comprising:
a display data output port for exporting to an Internet friendly display resolution for automatically detecting the resolution of the Internet friendly display resolution to automatically process the digital photo and video data into the Internet friendly display resolution data with the reduced amount of data matching with the resolution of the Internet friendly display resolution for displaying an image with a resolution at typically 320×240 pixels.

12. The electronic photo-video player and image storage device of claim 1 further comprising:
a user interface to display a setup menu to allow a user to select a resolution for exporting to a mobile display device to process the digital photo and video data into the mobile display data with the reduced amount of data matching with the resolution of the mobile display device.

13. The electronic photo-video player and image storage device of claim 1 further comprising:
a user interface to display a setup menu to allow a user to select a resolution for exporting to an Internet friendly display resolution to process the digital photo and video data into the Internet friendly display resolution data with the reduced amount of data matching with the resolution of the Internet friendly display resolution for displaying an image with a resolution at typically 320×240 pixels.

14. The electronic photo-video player and image storage device of claim 1 further comprising:
a processor to execute a program to automatically process the photo and video data into the display data with the reduced amount of data; and
a user controller for controlling the electronic photo-video player and image storage device to apply the display data for displaying and perusing the photo and video image captured by the digital camera.

15. The electronic photo-video player and image storage device of claim 14 wherein:
the user controller further comprises a controlling function for controlling the electronic photo-video player and image storage device to apply the digital photo and video data for displaying the photo and video image at a higher resolution as originally captured by the digital camera.

16. The electronic photo-video player and image storage device of claim 1 further comprising:
a processor to execute a program to automatically process the photo and video data into the display data comprising data of two different resolutions of a higher resolution and a correlated lower resolution each with the reduced amount of data; and
a user controller for controlling the electronic photo-video player and image storage device to apply the display data of the higher resolution and alternately of the correlated lower resolution for displaying and perusing the photo and video image captured by the digital camera.

17. The electronic photo-video player and image storage device of claim 1 further comprising:
a processor to execute a program to automatically process the photo and video data into the display data comprising data of two different resolutions of a higher resolution of HD quality (e.g., 1920×1080 pixels, 1280×720 pixels, etc.) and a correlated lower resolution of 320×240 pixels; and
a user controller for controlling the electronic photo-video player and image storage device to apply the display data of the higher resolution of HD quality (e.g., 1920×1080 pixels, 1280×72 pixels, etc.) and alternately of the correlated lower resolution of 320×240 pixels for displaying and perusing the photo and video image captured by the digital camera.

18. The electronic photo-video player and image storage device of claim 1 further comprising:
a remote controller to allow a user to carry out image editing and image display functions comprising delete, zoom in, zoom out, adjust colors, adjust brightness, adjust contrast, crop and rotate functions.

19. The electronic photo-video player and image storage device of claim 1 further comprising:
a data synchronizer for synchronizing the display data with an external mobile device.

20. The electronic photo-video player and image storage device of claim 19 further comprising:
a database manager to function with the data synchronizer for synchronizing and coordinating with an import/export interface of the external mobile device to update and synchronize data stored in a data storage module of the electronic photo-video player and image storage device.
